(19) United States
(12) Patent Application Publication
(10) Pub. No.: US 2007/0061871 A1
(43) Pub. Date: Mar. 15, 2007

(54) Authentication and account protection method and apparatus

(76) Inventors: Ryan Simpkins, Costa Mesa, CA (US); Michael Dunne, La Miranda, CA (US)

Correspondence Address: John Carr;Zuber & Taillieu, 9th Floor, 9595 Wilshire Blvd., Beverly Hills, CA, 90212, US

(21) Appl. No.: 11/213,065

(22) Filed: Aug. 25, 2005

(51) Int. Cl. H04L 9/32

(52) U.S. Cl. 726/4

(57) ABSTRACT

Software comprised of three components which work together to authenticate a user when he attempts to remotely access the website of a financial institution using his personal computer. The software gathers and saves a set of informational statistics (SOIS) relative to the user's personal computer. Later, when the user attempts to access the financial institution's website, the software sends a series of informational inquires to the user's personal computer. These informational inquires seek statistical informational relative to the user's personal computer preferably comprised of a random subset of the SOIS. The software gathers the information needed to respond to the series of inquiries and the responses are compared with the SOIS information previously stored. Based upon this comparison, the software sends a message to the financial institution advising of the relative certainty that the user is authentic.

### FIELD OF THE INVENTION

The invention generally relates to a method and apparatus for providing enhanced security to Internet access of confidential information stored on any secured server. More specifically, the invention relates to a method and apparatus for third party authentication and validation of a user before allowing the user to remotely access confidential information stored on a secure server, such as a banking or financial institution server.

### BACKGROUND OF THE INVENTION

As the Internet continues to grow, applications and use of the Internet are continually expanding. For example, user's my now use the Internet to conduct on-line banking in order to check their account balance, pay bills electronically, transfer funds to and from their individual accounts, increase lines of credit on credit cards, etc.

With the advent of on-line banking, there is an increased need for security and protection of a user's identity in order to ensure that only the correct banking customer has access to his/her account information via on-line banking. Many on-line banking systems use conventional encrypted passwords/user identification schemes in order to verify a user's identity. In these conventional schemes, a user will select a user id and a password on an initial log-in and this information will be encrypted and passed to the bank server. The information is then decrypted and stored on the bank server. Each subsequent time the user logs into the system, he/she will be prompted to enter his/her user id and password. The user will enter the same id and password and this will be compared with that information previously stored on the bank server. If the user id and password match then the user is allowed to continue with the on-line banking process. If the user id and password do not match, then the user is typically denied access and directed toward another page where the user may again attempt to log in to the account.

The problem with these conventional user id/password techniques is that it is far too easy for a “hacker” to crack these schemes, obtain the user id information, and log-into a user account over the Internet. Even despite the most advanced encryption schemes and techniques, these conventional user id /password techniques are seemingly never beyond a hacker's ability to decipher.

In an effort to add additional security, some systems have been developed which use a “hardware fingerprint” to identify a user. In these systems, a particular identifier, such as the serial number of the hard drive on the user's computer, is also recorded at the bank server at the initial log-in, on-line account set up stage. Thereafter, every time the user attempts to conduct on-line banking, the system will not only ask for the user id and password, but will also query the user's computer for the serial number of the hard drive. If the user id, password, and hard drive serial number all match then the user is allowed to continue with the on-line banking process. If either of the user id, the password, or the hard drive serial number do not match, then the user is typically denied access and directed toward another page where the user may again attempt to log in to the account.

While this type of “hardware fingerprinting” adds some additional security, the problem again with this type of security system is that it is far too stagnate, predictable and easy for a “hacker” to crack this scheme, acquire the particular user “hardware fingerprint” information, and log-into a user account over the Internet, even despite the most advanced encryption schemes and techniques.

### SUMMARY OF THE INVENTION

The invention is directed toward proprietary software comprised of three various software components running on three different computer systems/servers which all work together in order to provide added security to internet transactions. More specifically, the propriety software of the present invention includes a Client software component (normally resident on a user's personal computer system or server), an Interrogator software component (resident on the secured server where the information sought to be protected is stored, such as the server of a banking or financial institution where a user's account information is located), and a Stonewall server software component (located on at least one server in a group of specialized computer systems/servers—hereinafter referred to as “the Stonewall servers”).

In a preferred embodiment, a user will download the Client software component to his or her personal computer system/server from a pre-existing website where the software may be purchased/licensed for his or her use, in order to protect his or her financial accounts from unauthorized access. Once the software is fully loaded onto the user's personal computer, he or she registers for protection through a short registration process which is conducted over an Internet connection established between the user's personal computer system/server and the Stonewall servers. During the registration process, the Client software component and the Stonewall server software component communicate back and forth in order to gather a set of informational statistics (SOIS) relative to the user's personal computer system/server. The SOIS is sent to and stored in the Stonewall servers, along with at least one user identifier (such as a user name, user id, and/or user password).

The Stonewall server software component and the Interrogator software component communicate back and forth in order to activate the user as a protected user so that the next time the user attempts to log into and gain access to the secured server in order to access his or her financial account information via the Internet, the system will all work together in order to provide enhanced security.

Once registered, a user performs normal Internet log-on activities required to access the bank or financial institution's server/web site. Upon log on access attempt, the banking or financial institution computer system/server being accessed initiates the Interrogator software component, which then transmits a validation request to the Stonewall server software component located on the Stonewall servers.

Upon receipt of the validation request, secured communications via the Internet are established between the user's personal computer system/server (where the Client software component is located) and the Stonewall servers (where the Stonewall server software component is located). Once these secure communications are established, the Stonewall server software component will send an instant message to the user's personal computer system/server inquiring as to whether the user is, in fact, attempting to remotely access information from the remote secure server—i.e. the server located at the bank or financial institution. If the user responds positively, then a validation process is initiated. If the user responds negatively, the Stonewall server software component immediately notifies the Interrogator software component located on the banking or financial institution server that the user is not attempting to log into his or her financial account information and the banking or financial institution server can terminate the connection with the requesting party, who is obviously not the user.

In the validation process, the Stonewall server software component sends a series of informational inquires to the Client software component located on the user's personal computer system/server. These informational inquires seek statistical informational responses which constitute particularized statistical information relative to the user's computer system/server. In a preferred embodiment, the informational inquiries will seek statistical informational responses comprising a random subset of the SOIS, which has been earlier recorded and saved on the Stonewall servers. Accordingly, assuming that the SOIS is comprised of ten statistical informational items relative to the user's computer system/server, the series of informational inquiries may only ask for four randomly selected items out of these ten. The Client software component will gather the information needed to respond to each of the series of inquiries and will provide responses thereto. These responses will be sent to the Stonewall server software component, where they are then evaluated/compared with the SOIS information previously stored.

Based upon the results of this evaluation/comparison, the Stonewall server software component then sends a message to the Interrogator software component (located on the secured server where the information sought to be protected is stored—i.e. the server of the banking or financial institution), advising the remote banking/financial institution computer system/server of the relative certainty that the user is proper, valid and authentic. The remote internet banking or financial institution website then allows or denies access to the protected site/financial information, possibly at varying levels, dependent upon the degree of relative certainty sent by the Stonewall server software component.

It is noted that every time a user attempts to gain access to the remote computer system/server at his banking or financial institution, this process is repeated. In this regard, the series of inquiries which seek particular statistical informational items consistently changes such that the responses sought will always be a different subset of the SOIS what has been earlier recorded and saved on the Stonewall servers. This represents added security over previously known or utilized “hardware fingerprinting” techniques. Additionally, random additional information may be requested in order to obfuscate the process and prevent sniffing/spoofing from outside computers that will then have no way of knowing which information is actually needed and will be compared to the information contained in the previously recorded SOIS.

### DESCRIPTION OF THE DRAWINGS

FIG. 1 illustrates a system overview in which a preferred embodiment of the present invention is designed to operate;

FIGS. 2a and 2b illustrate the process for installing the Client software component on the client/user computer and completing an initial registration such that a user may thereafter utilize the software of the present invention for added security when accessing his or her private financial account information from a banking or other financial institution via the Internet;

FIGS. 3a and 3b illustrate a flow chart which shows a preferred embodiment of the steps taken by software of the present invention in order to protect a user when the user attempts to log into a secured server—such as the server of a financial/banking institution via on-line/Internet banking—in order to conduct access confidential and protected information—such as the user's account information—which is protected by the software of the present invention;

FIG. 4 illustrates the concept of how the series of inquiries generated by the Stonewall server software component requests statistical information which constitute a randomly selected subset of the SOIS, in accordance with a preferred embodiment of the present invention; and

FIGS. 5a and 5b illustrate a flow chart which shows an alternate embodiment of the steps taken by software of the present invention in order to protect a user when the user attempts to log into a secured server—such as the server of a financial/banking institution via on-line/Internet banking—in order to conduct access confidential and protected information—such as the user's account information—which is protected by the software of the present invention.

### DETAILED DESCRIPTION OF PREFERRED EMBODIMENTS

The invention is comprised of proprietary software which provides added security to Internet access of confidential and/or privileged information, such as financial and/or banking information which may be accessed via the Internet through on-line banking. The proprietary software is actual comprised of three various software components running on three different computer systems/servers which all work together in order to provide added security in order to properly authentic and validate any user requesting access to such confidential and/or privileged information.

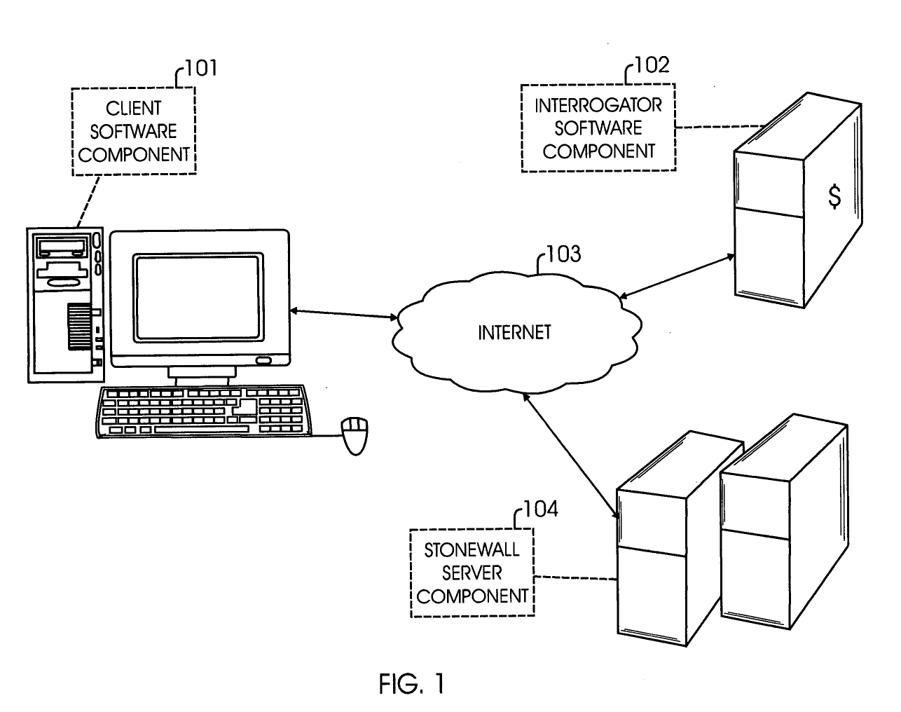

FIG. 1 illustrates a system overview in which a preferred embodiment of the present invention is designed to operate. As shown, the system includes a client/user's personal computer system or server (such as a home based personal computer) 101, a remote secured server 102—such as the server of a banking or other financial institution, which can be accessed by the client/user computer via the Internet, and a group of specialized computer systems/servers 103 (referred to as “the Stonewall servers”), which are also able to communicate with both the client/user's personal computer system or server 101 and the remote secured server, such as the server of a banking or financial institution 102 via the Internet.

In a preferred embodiment, the propriety software of the present invention includes a Client software component which preferably resides on a client/user's personal computer system or server 101 (such as home based PC), an Interrogator software component which resides on the remote secured server 102, where the information being accessed and sought to be protected is stored—such as the server of a banking or financial institution, and a Stonewall server software component which resides on the Stonewall servers 103, and which assists the remote secured server 102 in evaluating the identity and validity of the accessing party.

Installation and Registration Overview

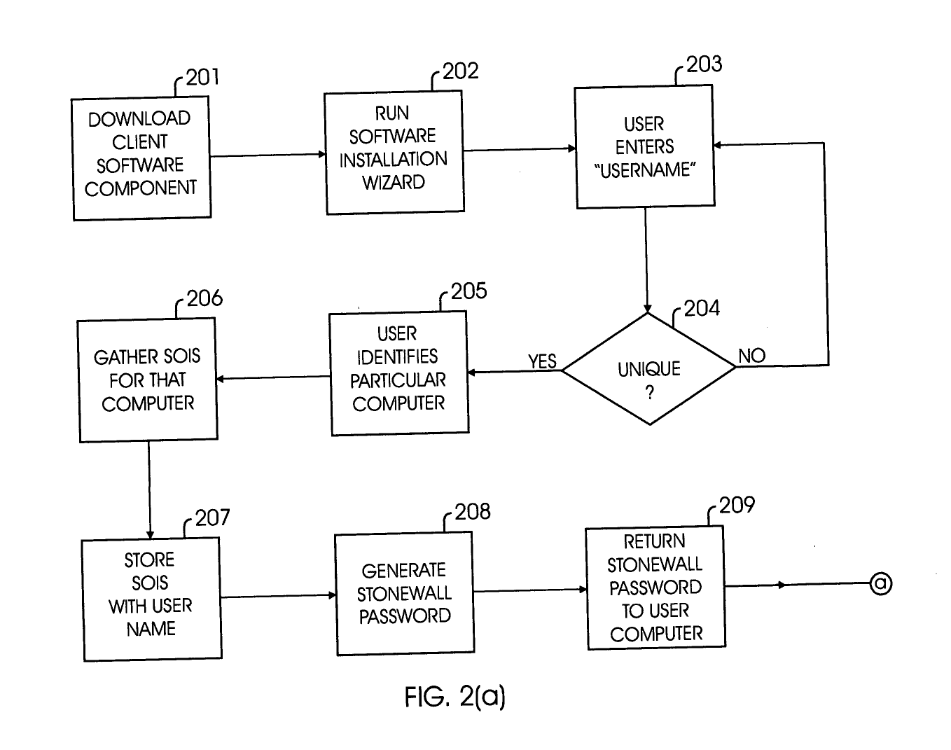

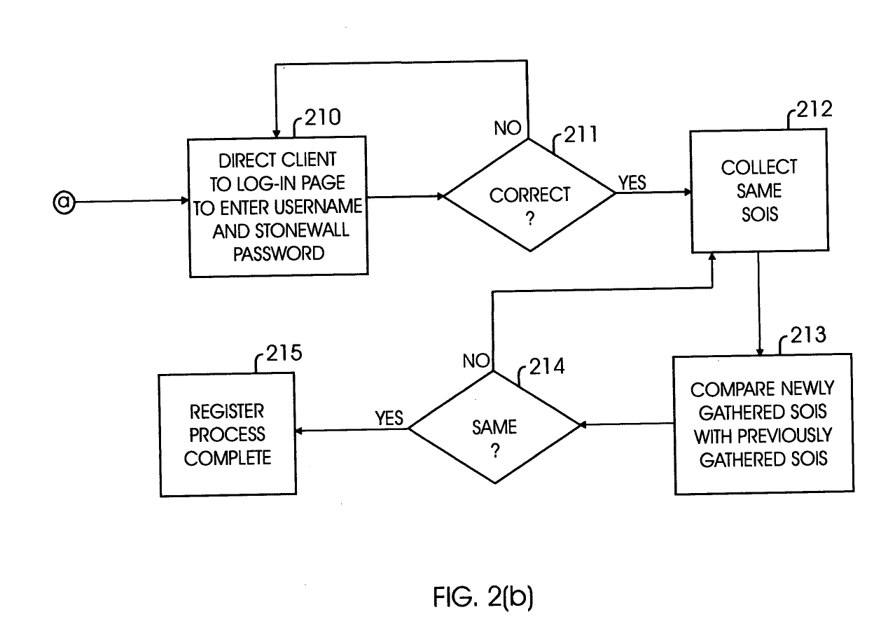

FIGS. 2a and 2b illustrate a flowchart which shows the process for installing the Client software component on the client/user's personal computer system or server and completing an initial registration such that a user may thereafter utilize the software of the present invention for added security when remotely accessing, via the Internet, confidential or private/privileged information stored on a secured server, such as financial account information stored on the server of a banking or other financial institution. As shown in FIG. 2a, in a preferred embodiment a user will download the Client software component to his or her personal computer system/server from a designated website 201 using any conventional web browser (such as Windows Internet Explorer, AOL or Netscape). Once the software has been downloaded, the user will run a pre-packaged installation software wizard 202 which will guide the user through the process and install the Client software component on the client/user's personal computer system/server.

After installation of the client software component has been completed, the user's web browser directs the client/personal computer to a registration page/screen, where the registration process is completed. Alternatively, the registration page/screen might be embedded within the Client software which transmits the registration information to the Stonewall Servers. In completing the registration process, the user is asked to select and input a proprietary user name 203. There may be an additional space provided for the user to enter his or her selected user name a second time for verification purposes. The user may also be prompted to enter his or her real name, address, telephone number and other possible personal identification indicia.

The Stonewall server software component of the software of the present invention receives this input from the user, via the Internet, and verifies the uniqueness of the user name selected by the user, by comparison to other user names 204. If the selected user name is unique, the user is then preferably asked to designate which computer he is currently registering (such as home, work, or portable lap top) 205. In a preferred embodiment, a user may install the Client software component on several different computer systems/server. As will be explained later, each computer system/server being registered will be associated with the user's proprietary user name, along with a set of information statistics (SOIS) specific to that particular computer system/server. Accordingly, in a preferred embodiment each user name may be associated with several different computer systems/servers and their corresponding SOIS. The user will need to go through a registration process for each individual computer system/server on which he or she may wish to be able to use the software of the present invention.

After the user has selected his or her proprietary user name and identified the particular computer system/server he or she is using/registering, the Client software component and the Stonewall server software component communicate back and forth in order to gather this SOIS relative to that particular user's personal computer system/server being registered 206. In a preferred embodiment, the SOIS includes computer specific information, often referred to as a “hardware fingerprint”, which may include such information as the type and version of the operating system platform installed on that computer system/server, the hard drive serial number for that computer system/server, the size of the hard drive, the remaining space available on said hard drive, the type of video graphics card used in the computer system/server, or the connection of any peripherals such as printer or mouse/keyboard. In short, the litany of possible statistical information which may be included within the SOIS is virtually unlimited but will be specific to that particular computer system/server.

Preferably, the SOIS will be a randomly selected set of particular hardware/software statistics which are particular to that computer, which is a subset of a much larger possible set of informational statistics. Accordingly assume the vast universe of statistical information which could be gathered includes up to one hundred (100) possible items (the much larger set of informational statistics), in a preferred embodiment the SOIS will be a randomly selected set of items from these 100 possible items. Accordingly, it is understood that the statistical items which make up the SOIS for any computer may be different for each user/computer, such that the same set of statistical items is not gathered consistently for each and every computer/user. Therefore, applying our original assumption that there are up to one hundred (100) possible statistical informational items available, a first computer system/server may have an associated SOIS which includes the statistical information for the first ten of these items, while a second computer system/server may have an associated SOIS which includes the statistical information for the last ten of these items.

Once the SOIS has been gathered by the Client software component, the SOIS is sent to the Stonewall servers and stored therein, along with the proprietary user name 207. As explained earlier, since a user is preferably allowed to install the client software component on several different computers, there may be up several separate SOIS saved for each individual user.

Once the SOIS for that particular user and designated computer system/server has been stored, the Stonewall server software component will generate a user specific or Stonewall password for that user 208. The Stonewall server software component then sends this Stonewall password by e-mail or instant message back to the user's personal computer system/server 209. Alternatively, the user may also be asked to enter a preferred password bearing a minimum number of letters/digits. In this case, the Stonewall server component software will also check to insure that this preferred password is original before moving forward with the registration process.

Referring now to FIG. 2b, the Client software component then preferably directs the client's web browser to a main log-in page, where the user will then enter his or her user name and the Stonewall password which was e-mailed or instant messaged to the client's host computer 210. Alternatively, the Stonewall server component may simply generate a request which is transmitted to the Client software component asking the user to enter his or her user name and Stonewall password. If the user has correctly entered his or her user name and Stonewall password, then the Client software component once again gathers the same SOIS from the user's computer system/server and transmits this information to the Stonewall server software component 211, where the Stonewall server software component will compare this newly gathered set of SOIS to the previously stored SOIS just to ensure that the user has completed the registration process and is recognized as a valid and authentic user 212. If the comparison of the newly gathered SOIS matches the previously stored SOIS, then this confirms that the user has properly registered that particular computer system/server and the registration process is complete for that particular computer system/server and the user will receive a confirming e-mail or instant message to this effect 213.

It has been explained that in a preferred embodiment, a user is able to install and register the software of the present invention on several different computer systems/servers. In a preferred embodiment, upon subsequent log in from a different computer system/server, the user will enter his or her user name and Stonewall password and the Stonewall server software component will provide a user prompt asking the user if he or she wishes to register another computer system/server or proceed with verification. If the user is logging in from another computer, he or she will affirm and the registration process will be completed for that particular computer system/server (beginning with Step 205 on FIG. 2a).

Registration of Accounts

After a user has installed the Client software component on his or her computer and completed the registration process, the user then needs to associate the confident information sought to be protected with the software of the present invention. In order to accomplish this, it is assumed that the secured server where the information is stored—such as the server of the banking or financial institution where the account(s) to be protected are located—is equipped with the Interrogator software component, which has been previously installed by the secure server administrator.

In order to register the accounts/information to be protected, the user accesses the secured server—such as the server of the banking or financial institution where the account sought to be protected is located. The secured server will typically have some type of user id/password log in process for the user to access the protected information. Once the user successfully logs into the secured server, the Interrogator software component (which has been installed on the secured server) prompts the user to see if he or she would like to associate his/her access to said secured server with the added protection of the present invention. If the user selects this option, the user is then preferably directed toward the Stonewall registration web page for that particular secured server or institution where the secured server is located, and the user enters his or her Stonewall username.

The Interrogator software component passes the Stonewall username to the Stonewall server component, via the Internet, and asks the Stonewall server component to validate the user. The Interrogator software component will also pass information about the origin of the user's transmission—i.e. the IP address where the user login/access attempt is coming from at that point in time—to the Stonewall server component.

The Stonewall server component will receive this information and will then attempt to verify the IP address from which the user has attempted to access the secured server. As explained in further detail hereinafter, in a preferred embodiment, the user is actively connected with the Stonewall servers whenever the user is connected to the Internet and a secure private connection is always running in the background which enables a user's personal computer system/server and the Stonewall servers to actively communicate at any time. Accordingly, the Stonewall servers are aware of an IP address from which the user's personal computer system/server is actively connected. The Stonewall server component will preferably compare this known IP address with the IP address provided by the Interrogator software component in order to verify that the point of origin of both communications is the same.

Assuming the points of origin match, the IP addresses are the same, then the Stonewall server component communicates with the Client software component in order to complete the user identification and authentication process, as described in further detail herein. Once the user identification and authentication process has been complete, the Stonewall server component communicates once again with the Interrogator software component locate on the remote banking/financial institution server, indicating that the user's private financial information can be linked to and associated with the user name.

Operational Overview

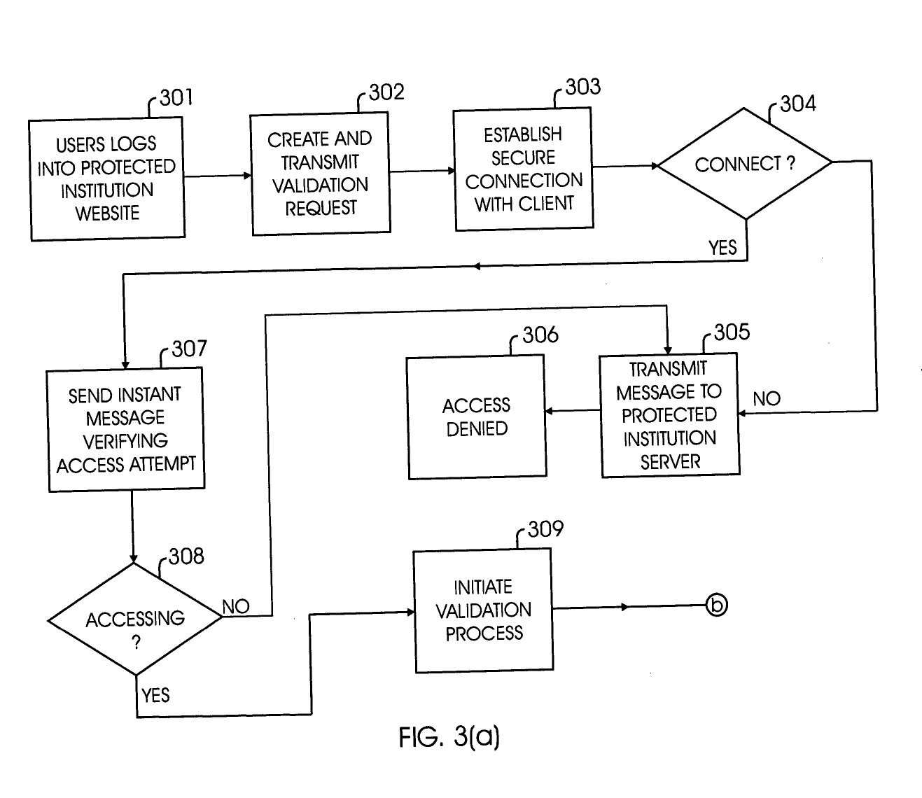

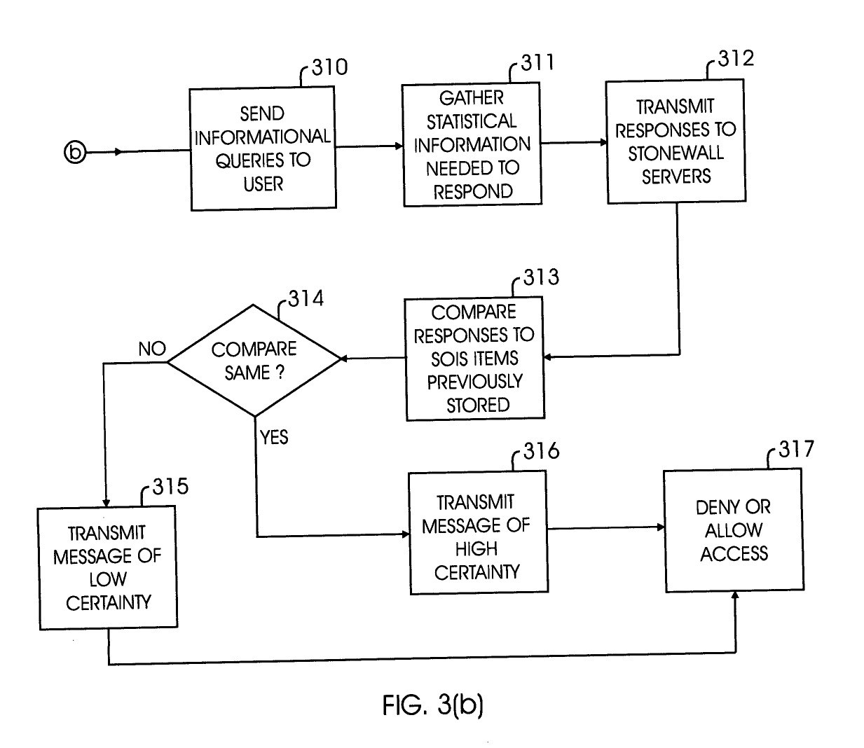

Once a user has fully installed the Client software component of the present invention, has completed the initialization/registration process, and his or her accounts have been properly associated and linked, the software is fully operational and able to provide enhanced security and protection. FIGS. 3a and 3b illustrate a flow chart which shows the steps taken by the software of the present invention in order to protect confidential and privileged information—such as a user's personal financial and account information—whenever anyone attempts to log into a secured server where such information is stored—such as the server of a financial or banking institution via on-line/Internet banking in order to conduct transactions from such an account protected by the software of the present invention.

As shown in FIG. 3a, a user performs normal Internet log-on activities required to access the secured server 301. Upon completing the normal log on access attempt, the Interrogator software component on the secured server being accessed creates a validation request, which is then transmitted to the Stonewall servers 302. Upon receipt of the validation request, the Stonewall server software component located on the Stonewall servers initiates secure communications with the Client software component located on the user's personal computer system/server via a previously established secure connection via the Internet 303. Alternatively, the Stonewall server software component will attempt to establish a secure connection with the Client software component via the Internet, based upon last known presence locations of the user—by cascading through last know user contact locations. If a secure connection cannot be established, then the user's personal computer is not connected to the Internet, thereby signaling to the Stonewall server software component that someone else may be trying to access the user's financial account information. The Stonewall server software will create a message to this effect, which is then transmitted from the Stonewall servers to the secured server at the financial institution 304. The financial institution will then sever the connection with the unauthorized intruder, who is not a recognized user 305.

Alternatively, when the Stonewall server cannot detect any live connections with the user, before automatically denying access the secured server could be instructed to send a message back to the user trying to access the secured server (such as the server at the banking or financial institution) asking if the user is running the software of the present invention. The user will be prompted to activate the software and try again. If the second request fails, then a denial message may be sent to the secured server (i.e. the server at the banking/financial institution).

If secure communications are established between the Client software component (i.e. the user's personal computer system/server) and the Stonewall server software component (i.e. the Stonewall servers on which the Stonewall server software component is resident), the Stonewall server software component will send an instant message to the user's personal computer system/server inquiring as to whether the user is, in fact, attempting to access information from the remote computer system/server located at the bank or financial institution 306. If the user responds positively, then the validation process is initiated 307. If the user responds negatively or fails to respond at all within a reasonable time period (thereby signaling to the Stonewall server software component that a user's personal computer that someone else may be trying to access the user's confidential and privileged information from the secured server), the Stonewall server software will create a message to this effect, which is then transmitted from the Stonewall servers to the secured server—i.e. the server at the banking or financial institution. The secured server will then sever the connection with the unauthorized intruder, who is not a recognized user.

As described earlier, assuming a user responds positively to the instant message (thereby indicating that he/she is in fact trying to access the confidential and protected information from the secured server), then the validation process is initiated 307. Referring now to FIG. 3b, in the validation process the Stonewall server software component, located on the Stonewall servers, will send a series of informational inquires to the Client software component located on the client's computer system/server 308. These inquires seek responses which constitute particularized information relative to the user's computer system/server hardware configuration and preferably comprising a random subset of the SOIS which has been earlier recorded and saved on the Stonewall servers. Therefore, assuming that the SOIS is comprised of ten statistical informational items relative to the user's computer system/server hardware configuration, the series of informational inquiries may only ask for four randomly selected items out of these ten.

The Client software component will gather the information needed to respond to each of the series of inquiries and will provide responses thereto 309. These responses (i.e. the informational statistics needed to reply to the inquiries which has been gathered by the Client software component) are sent to the Stonewall server 310, where the Stonewall server software component will then evaluate/compare the statistical responses with the SOIS information previously stored 311.

Based upon the results of this evaluation/comparison, the Stonewall server software component then sends a message to the Interrogator software component (located on the secured server attempting to be accessed), advising the remote secured server of the relative certainty that the user is proper, valid and authentic 312. In other words, if the comparison/evaluation of the responses to the series of inquires with the informational statistical items previously saved in the SOIS results in nearly identical statistical information, then positive results are given to the secured server—a high degree of certainty that the user has been authenticated. Similarly, if the comparison/evaluation of the responses to the series of inquires with the informational statistical items previously saved in the SOIS results in different statistical information, then negative results are given to the secured server—a low degree of certainty that the user has been authenticated. The protected site, i.e. the remote secured server attempting to be accessed by the user then allows or denies access, possibly at varying levels, dependent upon the degree of relative certainty sent by the Stonewall server software component.

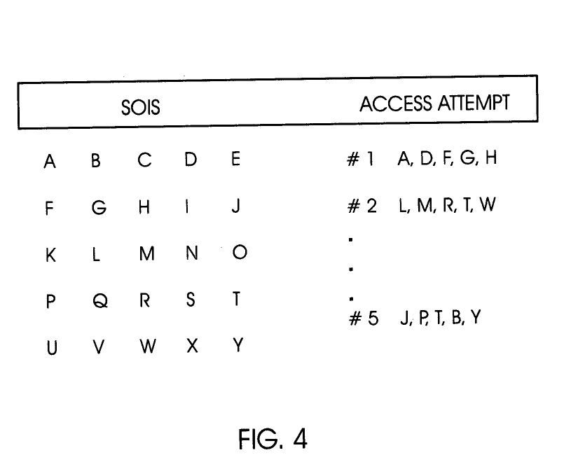

It is noted that every time a user attempts to gain access to the secured system/server, this process is repeated. Moreover, as explained earlier, in a preferred embodiment of the present invention, the series of informational items requested in the series of inquiries sent by the Stonewall server software component is a random subset of the SOIS which consistently changes, such that the responses sought will always be a different subset of the SOIS that has been earlier recorded and saved on the group of specialized computer systems. FIG. 4 illustrates the concept of how the series of inquiries requests statistical information which constitutes a randomly selected subset of the SOIS.

Referring to FIG. 4, there is shown an array which represents a typical SOIS in association with a preferred embodiment of the present invention. In the SOIS shown in FIG. 4, the array consists of twenty-five different statistical items (arranged in a five by five array for illustration purposes), although it is understood that the actual SOIS may consist of many more than twenty-five different statistical items. Directly to the right of the array is a list of items which represent responses to the series of inquiries for each subsequent attempt a user makes to access the protected information over the Internet from the secured server. Accordingly, one can see that on a first access attempt, proper responses to the series of inquiries will include statistical items matching those stored in the SOIS array locations A, D, F, G, and H. Still referring to FIG. 4, one can see that on a next account access attempt (which may occur days or weeks later), proper responses will include statistical items matching those stored in array locations L, M, R, T, W. Finally, one can see that on a most recent access attempt (designated as Attempt No. 5 in FIG. 4), the proper responses will include statistical items matching those stored in array locations J, P, T, B, and Y.

Additionally, in a preferred embodiment of the present invention, random additional information may be requested in order to obfuscate the process and prevent sniffing/spoofing from outside computers that will then have no way of knowing which information is actually needed and will be compared to the information contained in the previously recorded SOIS. Accordingly, in the examples given above there may actually be eight inquiries in the set but only five of the responses will be compared with the information contained in the SOIS.

Continued Development of the SOIS

In a preferred embodiment of the present invention, each time a user turns on a computer system/server upon which the Client software component of the present invention is installed and connects to the Internet, the Client software component will initialize and run in the background. When it initializes, it sends a signal to the Stonewall server software component located on the Stonewall servers, via the Internet, to let the Stonewall servers know that the user is logged onto the Internet and which computer system/server or location he/she is logged on from at such time.

During this time, the Client software component and the Stonewall server software component communicate back and forth in order to gather additional information or update previously retrieved information about the user's computer which will become part of the SOIS. Preferably, all of this will be done in the background and without the user's input or knowledge such that there is no need for the user to input any additional information or perform any additional tasks. Accordingly, in preferred embodiment of the present invention, the SOIS is continually updated and altered or changed to include new and updated information about the user's computer system/server hardware configuration, such that even the user himself will not know what specific statistics make up the SOIS for any one particular computer system/server at any one particular point in time.

Instant Messaging/E-Mail Notification

As explained earlier, in a preferred embodiment of the present invention, each time a user turns on a computer system/server upon which the Client software component of the present invention is installed and connects to the Internet, the Client software component will initialize and run in the background. When it initializes, it sends a signal to the Stonewall server software component located on the Stonewall servers, via the Internet, to let the specialized servers know that the user is logged onto the Internet and which computer system/server he or she is logged on from at such time.

This signal will include information about the user, including his or her username, Stonewall password and the IP address from which the computer is connected. From that time on, the Client software component and the Stonewall software component establish a secure link via the Internet between the user's computer and the Stonewall servers. This link is used to provide e-mail or instant messaging capabilities, as explained throughout herein. For example, as explained earlier, when a user then attempts to remotely access any protected information from a secured server—such as personal financial account information stored at his or her banking or financial institution—the Interrogator software running on the secured server sends a validation request to the Stonewall server software component, running on the Stonewall servers, asking for user authentication/validation. Upon receipt of the validation request, the Stonewall server software component sends an instant message to the user's personal computer system/server inquiring as to whether the user is, in fact, attempting to access information from the secured server. The Stonewall server software component sends this request over the secure connection previously established between the user's computer system/server and the Stonewall servers (i.e. the instant message is sent to the IP address identified and associated with the user's computer at the time the secure connection was established).

Accordingly, one can easily see that if a third party unauthorized computer attempts to log into the user's account information at his or her banking/financial institution protected by the software of the present invention, this instant message/e-mail is sent to the user's actual computer and not to this third party computer, and the user can then easily simply repudiate and reject the transaction. Therefore, the instant message/e-mail warning feature of the present invention provides an additional security not inherent in other prior art secured user identification/authorization systems.

Multiple Location Detection and Prevention

Another benefit of the software of the present invention is its ability to detect when a registered user is logged in from more than one location and to notify the user accordingly. This prevents unauthorized access to a user's accounts even when attempted from a computer registered with and recognizable by the software of the present invention.

As explained earlier, in a preferred embodiment of the present invention, the Client software component is initialized and running in the background whenever the user's computer is active/on and connected to the Internet. Accordingly, if a user's home computer is up and running and connected to the Internet (most high speed Internet connections are left active all the time) then there is a secure link between the user's home computer and the Stonewall servers.

If the user then goes to work and has the software of the present invention also installed on his computer at work, then when he activates his computer at work, the Client software installed on that computer will initialize. If the user then connects to the Internet using his work computer, a secure link is then established between his work computer and the Stonewall servers. At this point, the Stonewall server software component will recognize that the same user (a person having the same user name and/or Stonewall password) is connected and active from two different locations. The Stonewall server software will send an e-mail or instant message to both the user's home computer and the user's work computer asking if he or she wants to disconnect the active secure connection established between the user's home computer and the Stonewall servers, so that he or she may proceed with using his or her work computer.

If the user answers affirmatively, the secure connection established between the user's home computer and the specialized servers is severed. In this way, nobody can thereafter use the user's home computer to access his or her personal financial account information while he or she is away from the computer until a new secured connection is established.

Likewise, when the user returns home, if he or she has accidentally left her office computer on and connected to the Internet, the Stonewall server software component will send an instant or e-mail message to the user's home computer and the user's work computer, upon subsequent log-in attempt, notifying him or her of the other active connection and verifying that it should be terminated in order to proceed.

Intelligent Alteration of the SOIS

In an alternate embodiment of the present invention, the software of the present invention will also have the ability to alter or modify the information gathered and stored in the SOIS and to predict such alterations/modifications. More specifically, in an alternate embodiment of the present invention, the Client software component is configured to perform minor software operations to slightly alter any one or more of the measured hardware configurational items associated with the user's host computer on which it is installed. This will alter one or more of the statistical information items provided in response to the series of inquiries the next time information relative to that one or more particular configurational item is gathered and compared with the previously stored SOIS.

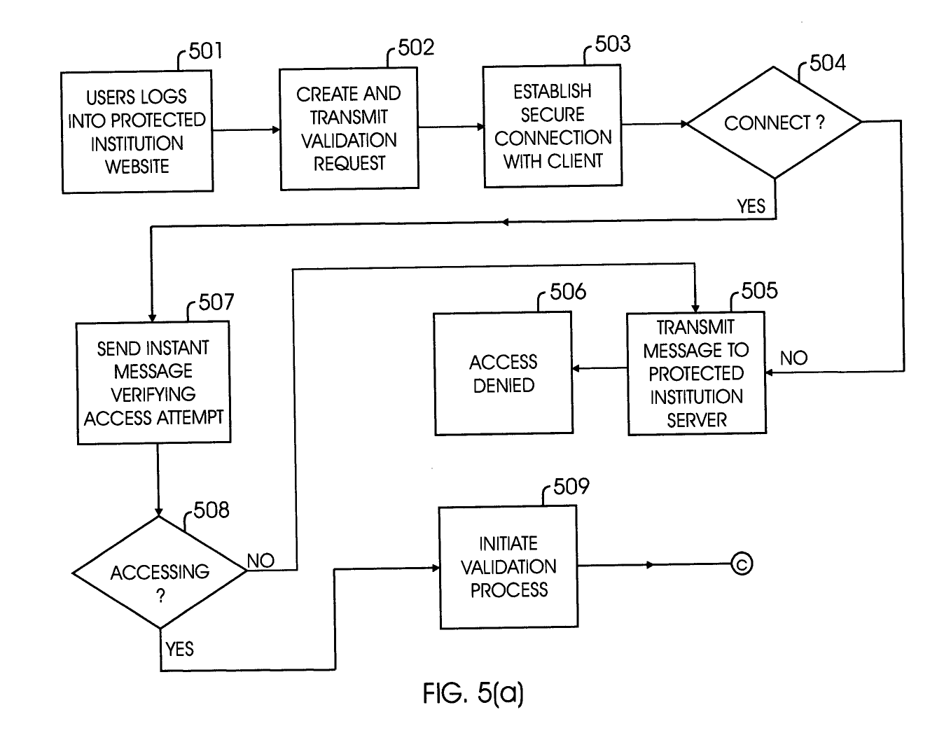

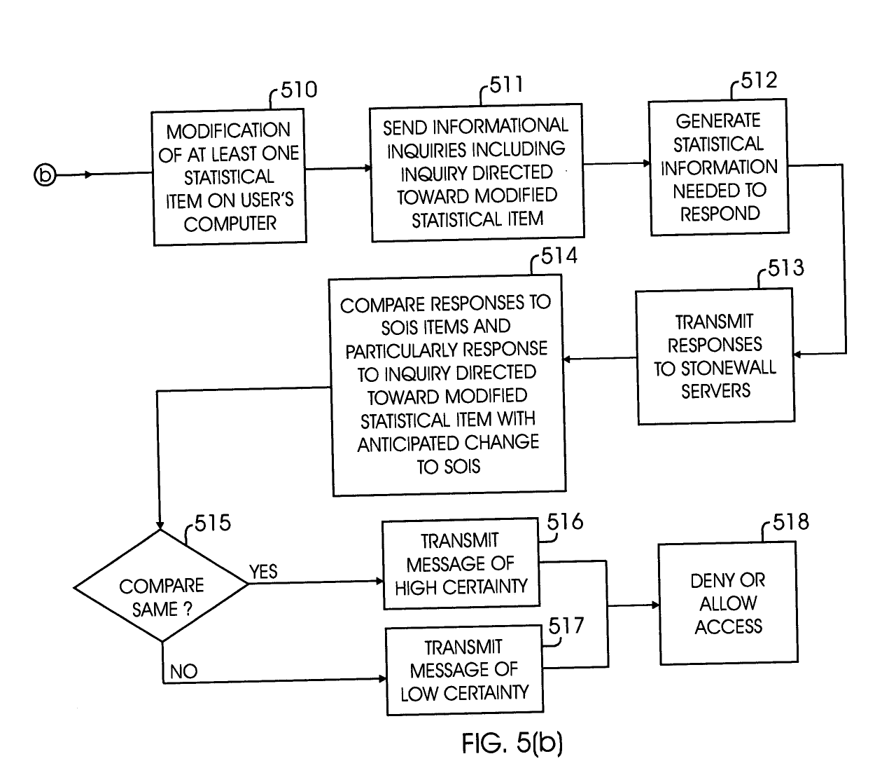

FIGS. 5a and 5b illustrate a flow chart which shows an alternate embodiment of the steps taken by software of the present invention in order to protect a user when the user attempts to log into and obtain information from a secured server protected by the software of the present invention—such as when a user attempts to access the website of a financial banking institution via on-line/Internet banking in order to conduct transactions from the user's account. As shown in FIG. 5a, steps 501 through 507 are identical to steps 301 through 307 described in FIG. 3 with reference to a preferred embodiment of the present invention.

Turning to FIG. 5b, as explained earlier the Client software component is configured to perform minor software operations to slightly alter any one or more of the measured hardware configurational items associated with the user's personal computer system/server on which it is installed 508. It is understood that this alteration/modification can really occur at any point in time after the original SOIS is established and saved. Much like the preferred embodiment, in this alternate embodiment the Stonewall server software component will generate and send a series of informational inquires to the user's personal computer, said inquires seeking responses which constitute particularized information relative to the user's personal computer system/server comprising a random subset of the SOIS which has been earlier recorded and saved on the Stonewall servers. The only difference is that in this alternate embodiment, the series of informational queries will include an inquiry specifically seeking a response relative to the altered informational statistic 509.

The Client software component will gather the information needed to respond to each of the series of inquiries and will provide responses thereto 510. These responses (i.e. the informational statistics needed to reply to the inquiries which has been gathered by the Client software component) are sent to the Stonewall servers 511, where the Stonewall server software component will then evaluate/compare the statistical responses with the SOIS information previously stored 512.

However, in this alternate embodiment, the Stonewall server software component is configured to anticipate the minor alteration/modification in the configuration of the user's hardware. Accordingly, when the newly gathered (and slightly altered or modified) statistical information is compared to the previously stored statistical item(s) of the SOIS, the change in any one or more such informational items is also predicted or anticipated. Therefore, if there is no change in the one or more such informational statistical items in which an alteration or modification is expected, then that will reduce the reliability score calculated by the Stonewall software component and transferred to the Interrogator software component resident on secured server where the protected information is stored.

By way of example only, assume that one of the statistical items gathered by the client software component could be the starting memory address location where the Client software component is resident on the user's personal computer system/server. However, in this alternate embodiment the Client software component could be configured to initiate a re-write to memory at select time intervals, thereby instructing the user's personal computer system/server to move the Client software component from one address location to another at specific intervals in time. At some later point in time, if one of the queries sent by the Stonewall server software component to the Client software component seeks the memory address location where such software component resides, and the memory address location provided in response to this query has not changed, that would trigger a lower reliability score when comparing the result to the SOIS, and factoring in the anticipated or expected alteration/modification in the address location.

This intelligent alteration of the SOIS feature adds additional security to the present invention never before seen in the prior art. Accordingly, on the remote chance that a third party was to intercept the SOIS information as it was initially being gathered, transferred to and stored on the set of Stonewall servers, with said third party being further able to then somehow determine which subset of the SOIS was going to be requested in a subsequent log-in verification/authentication event, that third party would still have no way of knowing that the Client software component had intentionally and purposefully changed one of the particular statistical items sought or that the Stonewall software component was configured to anticipate that alteration or modification. Accordingly, if the third party was to then simply send the original statistical informational item, without the expected change incorporated, this would trigger a lower reliability score when comparing the result to the SOIS and factoring in the anticipated or expected alteration/modification.

The preceding information accurately describes the major features and functionality of the present invention. While the description above contains many specifics, it should not be construed as a limitation on the scope of the invention, but rather as an illustration of exemplifications of particular embodiments thereof. One of ordinary skill in the art may make many changes, modifications, and substitutions without necessarily departing from the spirit and scope of the invention.

For example, although the invention has been described as including a Client software component which is installed on a user's personal computer system/server, it is understood that the Client software component can be adapted for installation on just about any known communications device through which access to a secure server, via the Internet might occur. Such communications device can include a cellular phone, a PDA, or a laptop computer.

Additionally, although most of the illustrations provided herein refer to protecting privileged and confidential information located on the secured server of a banking or financial institution, it is understood that the software of the present invention can be used to enhance security for any website, server or network that is user specific and password protected. Accordingly, the scope of the invention should be determined not by the embodiments described above, but by the appended claims and their legal equivalents.

What is claimed is:

1. User authentication and account protection apparatus for protecting unauthorized remote access, via the Internet, to information stored on a secured server, said apparatus comprising:
a Client software component located on a user's personal computer for gathering a set of informational statistics (SOIS) relative to said user's personal computer and transmitting said SOIS to a remote server location for storage;
an Interrogator software component located on the secured server for receiving an access request from a user requesting access to information stored on the secured server, and for further generating a validation request which seeks to identify the source of said account access request as originating from an authorized user;
a Stonewall software component located at the remote server location for receiving said validation request and in response thereto generating and sending a series of informational inquires to the Client software component located on the user's personal computer, said inquires seeking responses which constitute particularized information relative to the user's personal computer comprising a random subset of the SOIS which has been earlier recorded and saved at the remote server location; and
wherein the Client software component will gather the information needed to respond to each of the series of inquiries and will provide responses thereto, with said responses being evaluated/compared with the SOIS information previously stored at the remote server location.

2. User authentication and account protection apparatus as in claim 1:
wherein the Client software component is further configured to alter at least one informational statistic relative to said user's personal computer and the Stonewall software component is configured to anticipate such alteration such that when the Stonewall software component generates and sends the series of informational inquires to the user's personal computer, said inquires seek responses which constitute particularized information relative to the user's personal computer comprising a random subset of the SOIS which has been earlier recorded and saved, and in particular includes an inquiry seeking a response relative to the altered informational statistic;
further wherein the Client software component gathers the information needed to respond to each of the series of inquiries and provides responses thereto, including the altered informational statistic; and
further wherein the Stonewall software component compares said responses to the series of inquiries with the SOIS information previously stored and, in particular, compares the response to the inquiry seeking a response relative to the altered informational statistic with the anticipated alteration, in order to generate a reliability number which verifies whether the user should be allowed to access the information stored on the secured server.

3. The user authentication and account protection apparatus of claim 1, wherein the Stonewall software component then sends a message to the Interrogator software component, advising the secured server of the relative certainty that the user is proper, valid and authentic based upon the results of the evaluation/comparison.

4. The user authentication and account protection apparatus of claim 1, wherein the series of inquiries consistently changes such that the responses sought will always be a different subset of the SOIS what has been earlier recorded and saved.

5. The user authentication and account protection software of the claim 1, wherein random additional information may be requested in the series of inquiries, in order to obfuscate the process and prevent sniffing/spoofing from outside computers that will then have no way of knowing which responses are actually compared to the information contained in the previously recorded SOIS.

6. Account protection software for protecting unauthorized access to information stored on a secured server, said software comprising:
a Client software component running on any communications device capable of establishing an Internet connection with the secured server, said Client software component capable of transmitting information relative to the communications device over the Internet to a remote third party server, such information including a username which identifies an owner/user of the communications device and an IP address through which the communications device is actively connected;
an Interrogator software component running on the secured server which sends a validation request via the Internet to a remote third party server, asking for user authentication/validation whenever an attempt is to access the secured server from the communications device and via the Internet;
a Stonewall server software component, running on the remote third party server, which sends an instant message to the IP address contained in the signal received from the Client software component and associated with the communications device, said instant message inquiring as to whether the user is, in fact, attempting to access information located at secured server;
wherein the user can then easily simply repudiate the transaction by responding in the negative to the instant message, thereby providing additional security not inherent in prior art secured user identification/authorization systems.

7. Account protection software as in claim 6:
wherein the Client software component is configured to gather a set of informational statistics (SOIS) relative to said communications device and transmit said SOIS to the remote third party server for storage;
wherein the Stonewall server software component is further configured to generate and send a series of informational inquires to the Client software component located on the communications device, said inquires seeking responses which constitute particularized information relative to the communications device and comprising a random subset of the SOIS which has been earlier recorded and saved; and
wherein the Client software component will gather the information needed to respond to each of the series of inquiries and will provide responses thereto, with said responses then being evaluated/compared with the SOIS information previously stored.

8. Account protection software as in claim 7, wherein the Stonewall server software component then sends a message to the Interrogator software component, advising the secured server of the relative certainty that the user is proper, valid and authentic based upon the results of the evaluation/comparison.

9. Account protection software as in claim 7, wherein the series of informational inquiries consistently changes such that the responses sought will always be a different subset of the SOIS what has been earlier recorded and saved.

10. Account protection software as in claim 7, wherein random additional information may be requested by the Stonewall server software component in order to obfuscate the process and prevent sniffing/spoofing from outside computers that will then have no way of knowing which information is actually needed and will be compared to the information contained in the previously recorded SOIS.

11. Account protection software as in claim 7:
wherein the Client software component is further configured to alter at least one informational statistic relative to said communications device and wherein the Stonewall server software component is configured to anticipate such alteration such that when the Stonewall server software component generates and sends the series of informational inquires to the user's personal computer, said inquires include an inquiry seeking a response relative to the altered informational statistic;
further wherein the Client software component gathers the information needed to respond to each of the series of inquiries and provides responses thereto, including the altered informational statistic; and
wherein the Stonewall server software component compares said responses to the series of inquiries with the SOIS information previously stored and, in particular, compares the response to the inquiry seeking a response relative to the altered informational statistic with the anticipated alteration, in order to generate a reliability number which verifies whether the user should be allowed to access the information stored on the secured server.

12. A method for verifying or authenticating a user before allowing the user to remotely access confidential information stored on a secured server from his or her personal computer, the method comprising the steps of:
gathering a set of informational statistics (SOIS) relative to said user's personal computer and transmitting said SOIS to a remote server location for storage;
receiving a validation request at the remote server location from the secured server on which the confidential information is stored, said validation request seeking to verify or authenticate the user;
generating and sending a series of informational inquires to the user's personal computer, said inquires seeking responses which constitute particularized information relative to the user's personal computer comprising a random subset of the SOIS which has been earlier recorded and saved;
gathering information needed to respond to each of the series of inquiries and providing responses thereto; and
comparing said responses to the series of inquiries with the SOIS information previously stored in order to generate a reliability number which verifies whether the user should be allowed to access the confidential information located on the secured server.

13. The method of claim 12, further comprising the step of:
requesting random additional information from the user's personal computer in order to obfuscate the process and prevent sniffing/spoofing from outside computers that will then have no way of knowing which information is actually needed and will be compared to the information contained in the previously recorded SOIS.

14. The method of claim 12, comprising:
altering at least one informational statistic relative to said user's personal computer and anticipating such alteration;
generating and sending a series of informational inquires to the user's personal computer, said inquires seeking responses which constitute particularized information relative to the user's personal computer comprising a random subset of the SOIS which has been earlier recorded and saved, the series of informational queries including an inquiry seeking a response relative to the altered informational statistic;
gathering information needed to respond to each of the series of inquiries and providing responses thereto; and
comparing said responses to the series of inquiries with the SOIS information previously stored and, in particular, comparing the response to the inquiry seeking a response relative to the altered informational statistic with the anticipated alteration, in order to generate a reliability number which verifies whether the user should be allowed to access the confidential financial account information.

15. Method for protecting against unauthorized access via the Internet by any communications device to information stored on a secured server, said method comprising:
establishing an Internet connection between the secured server being accessed by the communications device and a third party server;
transmitting information relative to the communications device over the Internet from the secured server to the third party server, such information including a username which identifies an owner/user of the communications device and an IP address through which the communications device is attempting to access the secured server;
sending an instant message to the IP address contained in the information transmitted from the secured server to the third party server, said instant message inquiring as to whether the user is, in fact, attempting to access information located at secured server;
allowing a user to repudiate the access attempt by responding in the negative to the instant message, thereby providing additional security not inherent in prior art secured user identification/authorization systems.

16. User authentication and account protection apparatus for protecting unauthorized remote access, via the Internet, to information stored on a secured server, said apparatus comprising:
a Client software component located on a user's personal computer for gathering a set of informational statistics (SOIS) relative to said user's personal computer and transmitting said SOIS to a remote server location for storage;
a Stonewall software component located at the remote server location for generating and sending a series of informational inquires to the Client software component located on the user's personal computer, said inquires seeking responses which constitute particularized information relative to the user's personal computer comprising a random subset of the SOIS which has been earlier recorded and saved at the remote server location.

17. The user authentication and account protection apparatus of claim 16, wherein the Client software component will gather the information needed to respond to each of the series of inquiries and will provide responses thereto, with said responses being evaluated/compared by the Stonewall software component with the SOIS information previously stored at the remote server location.

18. The user authentication and account protection apparatus of claim 16, wherein the Stonewall software component sends a message to the secured, after evaluating/comparing said responses with the SOIS information previously stored, with said message advising the secured server of the relative certainty that a user is proper, valid and authentic based upon the results of the evaluation/comparison.
